(19) United States
(12) Patent Application Publication
(10) Pub. No.: US 2013/0342488 A1
(43) Pub. Date: Dec. 26, 2013

(54) CHOLESTERIC LIQUID CRYSTAL WRITING TABLET ERASED BY A PIEZOELECTRIC TRANSDUCER

(71) Applicant: Kent Displays Incorporated, Kent, OH (US)

(72) Inventors: Tod Schneider, Kent, OH (US); Oleg Pishnyak, Kent, OH (US); Andrew DeMiglio, Cuyahoga Falls, OH (US); Mark Lightfoot, Sterling, OH (US)

(21) Appl. No.: 13/927,647

(22) Filed: Jun. 26, 2013

Related U.S. Application Data
(60) Provisional application No. 61/664,195, filed on Jun. 26, 2012.

(51) Int. Cl. G06F 3/041

(52) U.S. Cl. CPC G06F 3/0416
USPC 345/173

(57) ABSTRACT

A display device includes a cholesteric liquid crystal writing tablet and a piezoelectric transducer. The piezoelectric transducer is subjected to a mechanical force that generates a voltage that is applied to the writing tablet that erases writing on the writing tablet or a portion thereof. A further feature is a display device comprising a cholesteric liquid crystal display and a piezoelectric transducer. The piezoelectric transducer is subjected to a mechanical force that generates a voltage that is applied to the display that places the display or a portion thereof in at least one of a color reflective planar state, a substantially transparent focal conic state and a gray scale state. Also featured is a method of erasing a cholesteric liquid crystal writing tablet.

### BACKGROUND OF THE INVENTION

Recently, the Boogie Board pressure sensitive cholesteric liquid crystal writing tablet, of Improv® Electronics has appeared on the market in which a pointed stylus or the finger nail can be used to write or trace an image on the surface of the tablet as described in U.S. Pat. No. 6,104,448. This tablet offers a considerable improvement over previous tablet technologies in that the image can be simply and instantly erased with the push of a button that applies a voltage pulse to electrodes in the tablet. In a cholesteric liquid crystal writing tablet, the liquid crystal is sandwiched between two substrates each carrying a transparent electrically conductive layer, which are spaced to a particular gap. The upper substrate is flexible and the bottom substrate is painted with a fixed opaque light absorbing dark background. Within the gap is a bistable cholesteric liquid crystal dispersed in a polymer network which can exhibit two textures, an essentially transparent (focal conic) texture and a color reflective (planar) texture. The spacing of the cell gap is usually set by plastic or glass spacers that are either cylindrical or spherical in shape. The transparent conductive layers are exposed on ledges for connecting to drive electronics so that a voltage or voltage pulses may be applied across the electrically conductive layers as is sufficient to initialize or erase an image.

The commercially available Boogie Board® writing tablet is initialized by applying voltage pulses to the electrodes to electrically drive the cholesteric material to the focal conic state. When one presses on the top substrate with a point stylus or finger, the liquid crystal is locally displaced. Flow induced in the liquid crystal changes its optical texture from essentially transparent to a brilliant reflective color at the location of the stylus. The polymer network limits the flow to produce a desired line width. The reflective color of the traced image contrasts well with the dark background of the lower substrate. An image traced by the stylus or finger will remain on the tablet indefinitely without application of a voltage until erased.

Erasure is accomplished by applying a voltage pulse to transparent conducting electrodes on the inner surface of the substrates that drive the cholesteric liquid crystal from its color reflective state back to its essentially transparent state. The required electrical driving pulses are typically provided by electronics which require a DC voltage supply, such as battery, for the operation. The driving schemes for switching cholesteric displays are described in U.S. Pat. Nos. 5,251,048, 5,644,330, 5,748,277, 5,889,566, 6,133,895 and 7,023,409, all incorporated herein by reference. All aspects of the cholesteric liquid crystal writing tablet, including the Boogie Board® described above, are suitable for the cholesteric liquid crystal writing tablet used in the display device of this disclosure described below.

While the lifetime of a battery in the Boogie Board® writing tablet is long, eliminating the battery would be an improvement since then the device would not need recharging or replacement of the battery. A more significant feature is in the cost reduction. When a battery is utilized, circuitry converts the DC battery voltage into an appropriate pulse or pulse sequence which adds to the cost of the writing tablet not only in cost of materials but more significantly in the cost of labor in manufacturing the writing tablet. It would therefore be advantageous to have a different erasing means that is free of batteries with circuitry that is simpler and potentially of lower cost.

### BRIEF DESCRIPTION

We disclose a display device including a cholesteric liquid crystal writing tablet that does not require a battery for erasing the image. The writing tablet is erased by a piezoelectric transducer. Piezoelectricity is a linear coupling between stress and electric polarization, discovered in 1880 by Pierre and Jacques Curie. Materials which exhibit piezoelectricity are organic materials such as PVDF material described, for example in U.S. Pat. No. 6,104,119, incorporated herein by reference. Known inorganic piezoelectric materials include lead zirconate titanate (PZT), barium titanate (BaTiO₃) and other piezoceramic materials. Piezoelectric materials have numerous applications in ultrasonics, hydroacoustics, frequency standards and in ferroelectric ceramics used in sensors, transducers, vibration dampeners and energy harvesters. A common use of piezoelectric transducers is in flame igniters used to ignite outdoor barbeque grills, fire places, cigarette lighters etc. The output of a piezoelectric transducer is usually a high voltage pulse following a mechanical impulse applied to mechanically strain the piezoelectric material. We have discovered that it is possible to make use of this voltage pulse to erase a cholesteric liquid crystal writing tablet. Additional circuitry to shape the waveform of the output signal and couple it to a cholesteric writing tablet may or may not be used. This innovative utilization of the piezoelectric transducer for the cholesteric writing tablet allows for the elimination of batteries and minimizes or completely eliminates the use of the driving electronics to reduce the product cost.

A first embodiment of the disclosure features a display device comprising a cholesteric liquid crystal writing tablet and a piezoelectric transducer. The piezoelectric transducer is subjected to a mechanical force that generates a voltage that is applied to the writing tablet that erases writing (including drawing and images) on the writing tablet.

Referring now to specific features of the first embodiment, the erasing can be carried out by the voltage placing the writing tablet or a portion thereof in a focal conic texture. The display device may be constructed to include no power source (e.g., no batteries) besides the piezoelectric transducer. Further, a piezoelectric material of the piezoelectric transducer can comprise a piezoceramic crystal or piezoelectric polymer. The piezoceramic crystal can comprise barium titanate or lead zirconate titanate. The piezoelectric polymer can comprise (polarized) polyvinylidene fluoride (PVDF) or a (polarized) copolymer thereof. The piezoelectric material of the piezoelectric transducer can comprise a complex of piezoelectric powder or piezoelectric particles dispersed in polymeric binder. The display device can comprise a “snap-action switch” for providing a mechanical force to the piezoelectric material resulting in the voltage that erases the writing on the writing tablet. In another variation, the piezoelectric transducer can comprise two electrical electrodes electrically connected to leads of the writing tablet. Electrical conductors (e.g., electrical wires) can extend from the piezoelectric transducer (from its electrodes) to display electrically conductive layers disposed on either side of cholesteric liquid crystal of the writing tablet (to the leads of the writing tablet connected to the display conductive layers), the voltage being applied along the conductors to the display electrically conductive layers. Any of the display electrically conductive layers of this disclosure can be continuous (covering substantially the entire viewing area of the writing tablet or other liquid crystal display), or may be patterned or segmented.

The piezoelectric transducer can comprise a stack of polarized piezoelectric sheets of piezoelectric polymer in which each of the piezoelectric sheets is coated with an electrically conductive layer on the upper and lower side of the piezoelectric sheet; adjacent electrically conductive layers being alternatively electrically connected to a different one of the display electrically conductive layers. Any display device of this disclosure can comprise a device that mechanically applies a force to the piezoelectric transducer (e.g., the stack of piezoelectric polarized polymer sheets or the piezoelectric ceramic) that results in applying the voltage to the cholesteric liquid crystal display (e.g., the cholesteric liquid crystal display writing tablet). In another aspect, the writing tablet is flexible (e.g., and contains no rigid housing); the piezoelectric transducer comprising the stack of polarized piezoelectric sheets of piezoelectric polymer is laminated to the writing tablet on a side opposite an imaging side, and whereby the mechanical force is achieved by bending the laminated writing tablet and piezoelectric transducer together resulting in applying the voltage that erases writing on the writing tablet.

Still further, the display device can comprise coupling circuitry for the transfer of electrical charge from the piezoelectric transducer to the writing tablet such as may be needed for shaping the output signal or for minimizing signal loss. General design requirements for circuitry coupling a piezoelectric transducer to various kinds of loads can be found, for example, in the Piezo Film Technical Manual of SI Images, Inc., publically accessible as least as early as Jun. 6, 2013. The piezoelectric transducer can be subjected to a mechanical force (e.g., by hand bending or using a mechanical device) that strains the material that forms the transducer sufficient to generate the voltage of an amplitude and duration. A mechanical device (e.g., a spring-loaded hammer or striker) can be used to strike the piezoelectric transducer (e.g., ceramic piezoelectric stack) when operated, to apply the mechanical force and thereby generate a voltage. The voltage can comprise one or more voltage pulses. There can be a permanent electrical connection between the piezoelectric transducer and the writing tablet along which the voltage is applied.

Specific features described in the Detailed Description can be used in the first embodiment, and along with the specific features described above that are useful in the first embodiment, in any combination.

A second embodiment of the disclosure features a display device comprising a cholesteric liquid crystal display and a piezoelectric transducer. The piezoelectric transducer is subjected to a mechanical force that generates a voltage that is applied to the display that places the display or a portion thereof in at least one of a color reflective planar state, a substantially transparent focal conic state and a gray scale state.

The specific features described in the Detailed Description and above in connection with the first embodiment, may be used in connection with the second embodiment, in any combination. It should be appreciated that reference to a cholesteric liquid crystal display throughout this disclosure is not limited to a writing tablet, which is an example of such a display or to an eBoard which includes two or more such writing tablets, but encompasses all types of cholesteric liquid crystal displays.

A third embodiment features a method of erasing the cholesteric liquid crystal writing tablet as described in the first embodiment comprising applying a mechanical force that deforms the piezoelectric transducer so as to apply the voltage to the writing tablet that erases writing on the writing tablet or a portion thereof

Referring to specific features of the third embodiment, the erasing can be carried out by the application of the voltage placing the writing tablet or a portion thereof into a focal conic texture. There can be a permanent electrical connection between the piezoelectric transducer and the writing tablet along which the voltage is applied. The display device can be constructed such that no other voltage is applied to the writing tablet besides the voltage applied by the piezoelectric transducer (e.g., no battery is needed in the display device). The piezoelectric transducer can comprise two electrical (conducting) electrodes electrically connected to (electrically conducting) leads of the writing tablet, and the method applies the voltage from the electrodes to the leads. Electrical conductors (e.g., wires) can extend from the piezoelectric transducer (from its leads) to display electrically conductive layers disposed on either side of the cholesteric liquid crystal layer of the writing tablet (to the leads of the writing tablet connected to the display conductive layers), and the voltage can be applied along the conductors to the display electrically conductive layers. Coupling circuitry can be used for the transfer of electrical charge from the piezoelectric transducer to the writing tablet such as may be needed for shaping the output signal or for minimizing signal loss. The application of force or pressure to the piezoelectric transducer can generate the voltage of an amplitude and duration. The voltage can comprise one or more voltage pulses.

Regarding further specific features of the method, the method can comprise providing a device that applies the mechanical force to the piezoelectric transducer that results in application of the voltage to the writing tablet. The piezoelectric transducer can comprise a stack of piezoelectric sheets comprising piezoelectric polymer, electrically connected in parallel and the method can comprise providing a device that applies the mechanical force that bends the piezoelectric sheets so as to result in application of the voltage to the writing tablet. In any aspect of the method, the deforming can occur by applying a mechanical force that bends the piezoelectric transducer. In all embodiments of this disclosure, reference to a mechanical force means a force applied using a mechanical device or by hand as opposed to other non-mechanical forces such as electrical force.

Many additional features, advantages and a fuller understanding of the embodiments of the disclosure will be had from the accompanying drawings and the detailed description that follows. It should be understood that the above Brief Description describes embodiments of the disclosure in broad terms while the following Detailed Description describes embodiments of the disclosure more narrowly and presents specific embodiments that should not be construed as necessary limitations of the invention as broadly defined in the claims.

### BRIEF DESCRIPTION OF THE DRAWINGS

FIG. 1: Schematic of a display device including a cholesteric liquid crystal display electrically connected to a piezoelectric transducer and circuit electronics.

FIG. 2: Schematic of a display device including a cholesteric liquid crystal display electrically connected to a piezoelectric transducer made of flexible PVDF material.

FIG. 3a: Photograph of a cholesteric liquid crystal display writing tablet of Example 1 with a written image, which is electrically connected to a piezoelectric PVDF transducer.

FIG. 3b: Photograph of the writing tablet of FIG. 3a erased to the focal conic state after flexing the piezoelectric PVDF polymer material.

FIG. 4: Schematic illustrating a display device including an integrated flexible writing tablet and piezoelectric transducer.

FIG. 5: Schematic of a display device including a cholesteric liquid crystal display electrically connected to a ceramic piezoelectric igniter transducer and detailed added circuitry.

It should be appreciated that like reference numerals represent the same or similar parts throughout the several views of this disclosure.

### DETAILED DESCRIPTION

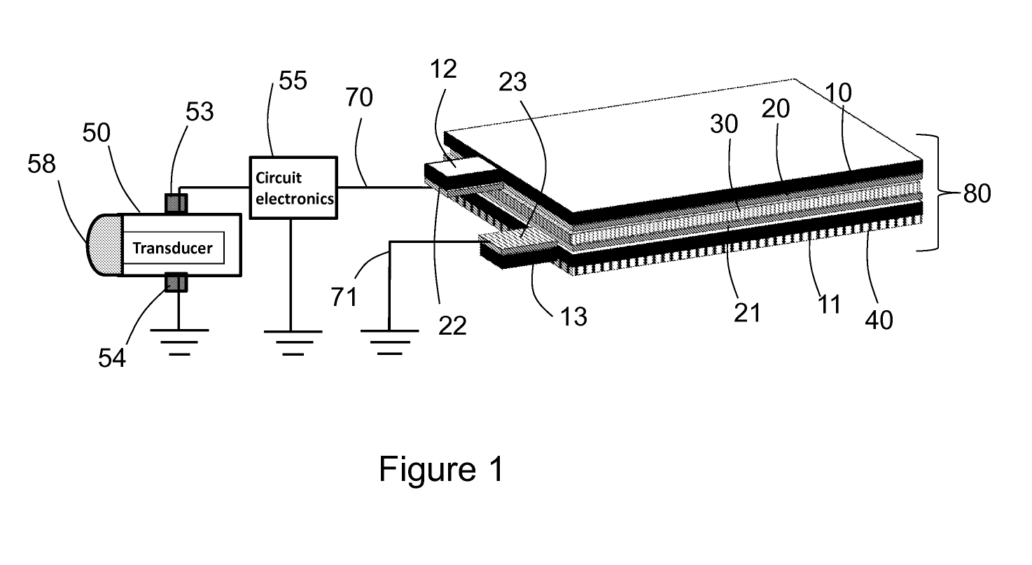

FIG. 1 shows a schematic of a display device including a cholesteric liquid crystal display writing tablet 80 connected to a piezoelectric transducer 50 through optional circuit electronics 55. Transducer 50 can be activated by an optional mechanical device 58, or by hand, which applies a mechanical force that causes the transducer to generate an electric signal for erasing the display device. In some cases circuit electronics 55 are desired to shape the waveform of the electric signal generated by the piezoelectric transducer and to transfer the electrical signal from the transducer to the writing tablet. The circuit 55 may be a simple resistive potential divider or may involve diodes or other electrical elements (e.g., semiconductor elements). Examples below are provided for a transducer requiring no coupling circuit and a different type of transducer with which a coupling circuit is utilized. Electronic characteristics of piezoelectric transducers are known in the art as, for example, can be found in the Piezo Film Technical Manual of SI Images, Inc., publically accessible as least as early as Jun. 6, 2013, which is incorporated herein by reference in its entirety. The cholesteric writing tablet 80 includes a top substrate 10 with a conductive layer 20, a bottom substrate 11 with a conductive layer 21, a light absorbing layer 40 as an outermost layer on one side of the display and cholesteric liquid crystal layer 30 disposed between the conductive layers 20 and 21. The cholesteric liquid crystal layer 30 includes cholesteric liquid crystal material dispersed in a polymer matrix. The conductive layers 20 and 21 are continuous and extend over substantially the entire viewing area of the display. This effectively makes the display a single pixel display.

The writing tablet could be tiled to other writing tablets to make a larger device such as an eBoard as disclosed in U.S. patent application Ser. No. 13/897,004, entitled “Cholesteric Writing Board Display Device,” which is incorporated herein by reference in its entirety. Each writing tablet of the eBoard could be erased by a single piezoelectric transducer or possibly multiple writing tablets could be wired so as to be erased by a single piezoelectric transducer. The single writing tablet display has ledges 12 and 13 which support terminals 22 and 23, electrically connected to display conductive layers 20 and 21 respectively. Suitable ledges on writing tablets of the eBoard are disclosed in the 13/897,004 application. Electrically conducting leads 70 and 71, as illustrated in FIG. 1, connect writing tablet 80 to the optional coupling circuit 55. The output terminal 54 of transducer 50 is connected to ground whereas output terminal 53 of transducer 50 is connected to circuit electronics 55. Alternatively, if coupling circuitry is not required, the writing tablet may be connected directly to the transducer. In this case (not shown in FIG. 1) lead 70 would be connected directly to terminal 53 with circuit electronics removed.

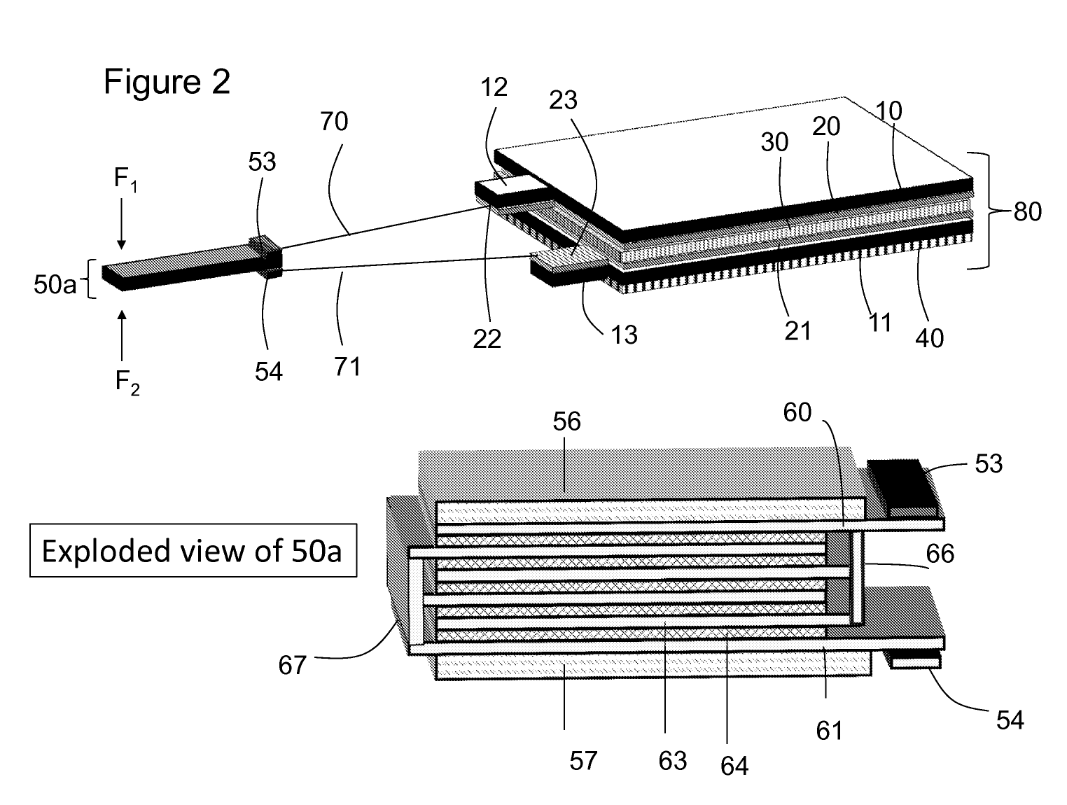

FIG. 2 is an illustration of a flexible piezoelectric transducer 50a made of a sheet of PVDF material. The polarized fluoropolymer PVDF, polyvinylidene fluoride, has very high piezoelectric activity and is processed in the form of a thin film that is flexible, light weight and rugged. A transducer is made by coating a polarized film on both sides with conducting material (see for example Piezo Film Technical Manual of SI Images, Inc., publically accessible at least by Jun. 6, 2013). When the film is flexed a charge is generated on the conductors. The amplitude of the electrical signal is directly proportional to the mechanical deformation of the piezoelectric material as well as the size of the film. The films may be stacked on top of one another and connected in parallel to increase the amplitude. See Example 1 on the preparation of such a stack. Further, the piezoelectric transducer (e.g., PVDF stack) may be incorporated in or with a snap-action device that provides a mechanical force that deforms the stack and provides a resulting voltage output pulse. FIG. 2 illustrates the application of such a stack of PVDF films for use as a transducer that provides a voltage signal for erasing a cholesteric liquid crystal display. In FIG. 2, the piezoelectric PVDF transducer 50a has output terminals 53 and 54 electrically connected to conductive layers 60 and 61 on top and bottom surfaces of the stack respectively. Conductive wires 70 and 71 directly connect terminal 53 of the piezoelectric transducer with terminal 22 of the writing tablet 80 and transducer terminal 54 with terminal 23 of the writing tablet 80, respectively. A protective dielectric coating (i.e., Mylar) 56 and 57 is applied to the top and bottom conductive layers 60 and 61, respectively. Each piezoelectric layer 64 is coated with a thin conductive layer 63 that carries charge once the piezoelectric material has been flexed. These adjacent conductive layers 63 are alternately connected to conductors 66 and 67, which are electrically connected to the top and bottom conductive layers 60, 61, respectively. That is, one conductor 63 is electrically connected to conductor 66 while the next adjacent conductor 63 is electrically connected to conductor 67, the conductors 66 and 67 not being in direct electrical contact with each other in the example shown. The transducer terminals 53 and 54 are connected to the writing tablet 80 through the wires 70 and 71 to the terminals 22 and 23 of the writing tablet, respectively. In this case coupling electronic circuitry is not used. The PVDF piezoelectric transducer is activated by bending it back and forth applying mechanical forces F₁ and F₂ (using a mechanical actuator or by hand) as schematically shown in FIG. 2 with the other end of the film being fixed in place. The force applied to the piezoelectric material causes deformation of the film resulting in a sequence of the electric pulses capable of placing the display 80 in the desired optical state; i.e., the focal conic state, as is suitable to erase the writing tablet.

Various types of devices for mechanically applying a force that deforms (e.g., bends) the piezoelectric sheets resulting in application of the voltage to the writing tablet may be suitable for use in this disclosure, such as those described in the Piezo Film Technical Manual of SI Images, Inc. reported here and in U.S. Pat. No. 6,104,119, which is incorporated herein by reference in its entirety. One such example device is a snap-action device in which the piezoelectric sheets are laminated onto a substrate that quickly snaps from one position to another when pressed. Such devices are known as snap-action piezoelectric switches. Snap-action piezoelectric switches typically include a dome-shaped snap disc to which the piezoelectric material is attached, and a switch button that is pressed by the user. When the switch button is pressed, the switch button deforms the snap disc within the switch and causes it to snap from one position to another.

Other example piezoelectric devices suitable for use as a transducer for erasing cholesteric displays include a ceramic piezoelectric stack and a mechanical striker (e.g., a spring-loaded hammer) that strikes the piezoelectric stack when operated, to apply a mechanical force and thereby generate a voltage. The voltage generated by the piezoelectric stack when hit by the striker is used to erase the display. A mechanical striker can also be used to deform (e.g., bend) piezoelectric sheets, to thereby apply a voltage to erase the display.

A prototype of a cholesteric writing tablet using a PVDF piezoelectric transducer is described in Example 1.

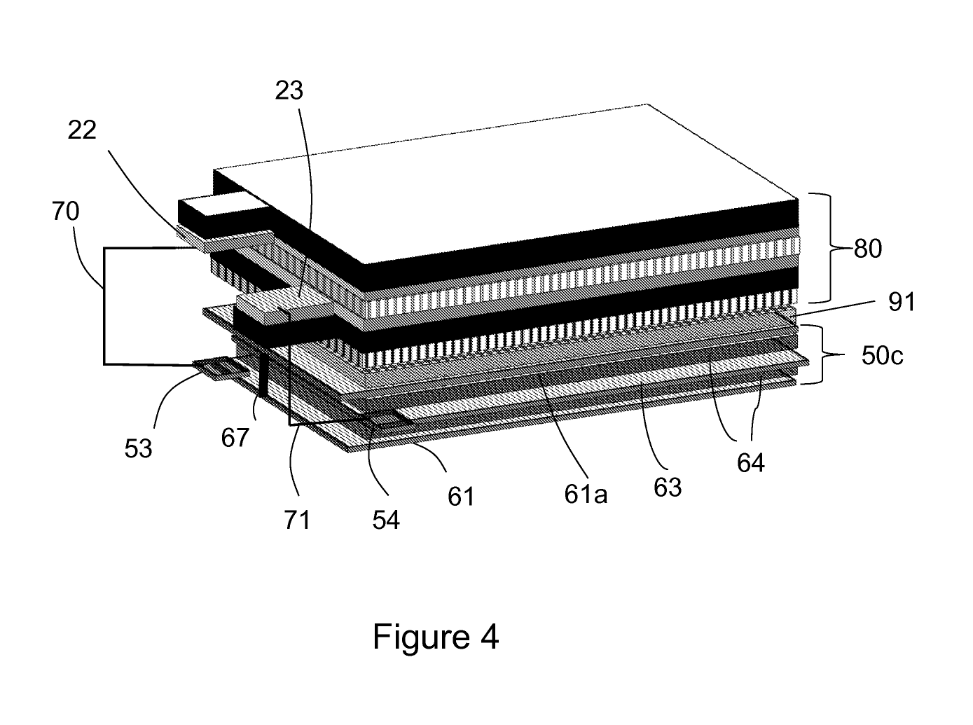

An advantage of the PVDF piezoelectric transducer is its flexibility and its thin film profile. These features allow for its lamination on the reverse side (side opposite the imaging side) of the writing tablet display. The writing tablet display is also flexible since it is made from thin flexible polymer substrates. The commercial Boogie Board® cholesteric liquid crystal writing table display is mounted on a rigid backing or housing; however, a rigid backing is unnecessary for operation as a display of this disclosure. Capitalizing on these features, another embodiment for a piezoelectric erased writing tablet is an integrated version where the flexible PVDF piezoelectric transducer is laminated directly on the flexible writing tablet display without the rigid backing An integrated device is illustrated in FIG. 4 where a double stacked PVDF transducer 50c is laminated to the non-viewing (back) side of the cholesteric liquid crystal display writing tablet 80 with an inner layer of adhesive 91 disposed between the stacked PVDF transducer 50c and the writing tablet 80. The PVDF double stack transducer includes two polarized PVDF layers 64 separated by an electrically conducting layer 63 which is connected to output terminal 54. The electrically conducting layer electrodes located on the top and bottom of the stack, 61 and 61a, respectively, are electrically connected together by electrical conductor 67, which are further connected to output terminal 53. It is to be appreciated that the PVDF transducer is not necessarily limited to a double stack but could, for example, consist of 5 stacked layers of PVDF film with electrical conductors on each side as illustrated in the Exploded view of transducer 50a in FIG. 2. Further, the transducer could consist of any number of such PVDF layers and associated conductor layers as is suitable to implement a working integrated device. Lead 70 electrically connects transducer terminal 53 to terminal 22 of the writing tablet and lead 71 electrically connects transducer output terminal 54 to terminal 23 of the writing tablet. When the entire construction of the integrated device (writing tablet and laminated PVDF transducer) is flexed so as to apply a mechanical force that bends the piezoelectric transducer 50c, charge generated by the PVDF transducer is applied to the interconnecting terminals 22 and 23 of the writing tablet and erases any writing (including drawing and images) that may have been traced on the display by a stylus. FIG. 4 shows the transducer 50c directly coupled to the writing tablet 80. However, if one desires more effective coupling, circuit electronics may be added as illustrated in FIG. 1. In this case, the electronic circuit 55 could be developed with state of the art electronic knowledge based upon the known electrical characteristics of both the transducer and the display.

### Examples

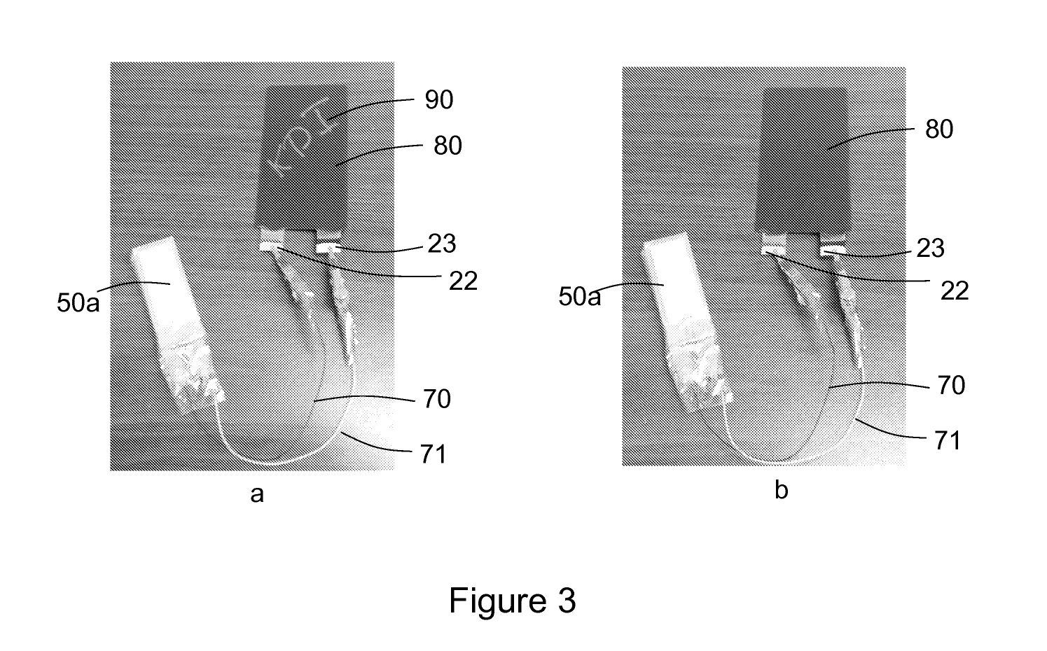

Example 1. A reflective cholesteric liquid crystal display writing tablet 80 with the size of active area 38 mm×76 mm shown in FIG. 2 was made by forming a cholesteric liquid crystal layer (cholesteric liquid crystal material dispersed in a polymer matrix) by a PIPS technique described in U.S. Pat. No. 6,104,448, U.S. patent application Publications 12/152,729 and 12/220,805, which are all incorporated herein by reference in their entireties, and disposed between a 5 mil PET top substrate and a 7 mil PET bottom substrate with conductive polymer layers on one side of both substrates as illustrated in FIGS. 1 and 2. As illustrated in the exploded view of FIG. 2, a PVDF piezoelectric transducer 50a was constructed by stacking 20 strips of PVDF material PZ-02 (6 mm×41 mm×0.2 mm size) 64 purchased from Image SI, Inc. The adjacent conducting layers 63 are alternatively electrically connected to conductors 66 and 67, which are electrically connected to the top and bottom conductive layers 60, 61, respectively. The conductors 60, 6l are connected to the display 80 through the wires 70 and 71 to the terminals 22 and 23 of the writing tablet 80, respectively. A pointed stylus was used to write an image 90 on the writing tablet 80 as shown in the photograph of FIG. 3a (the bright written image 90 being in the planar texture and the dark areas of the display being in the focal conic texture). Depending on the amplitude and frequency of the applied bending force, the PVDF stack produced from 10V to 35V voltage pulses with a pulse width from 100 ms to 300 ms. After bending the stack 50a back and forth 4 times by hand such voltage pulses were achieved and thus, the writing 90 on the display 80 was erased by placing the liquid crystal of the entire viewing area in the focal conic texture as shown in photograph—FIG. 3b.

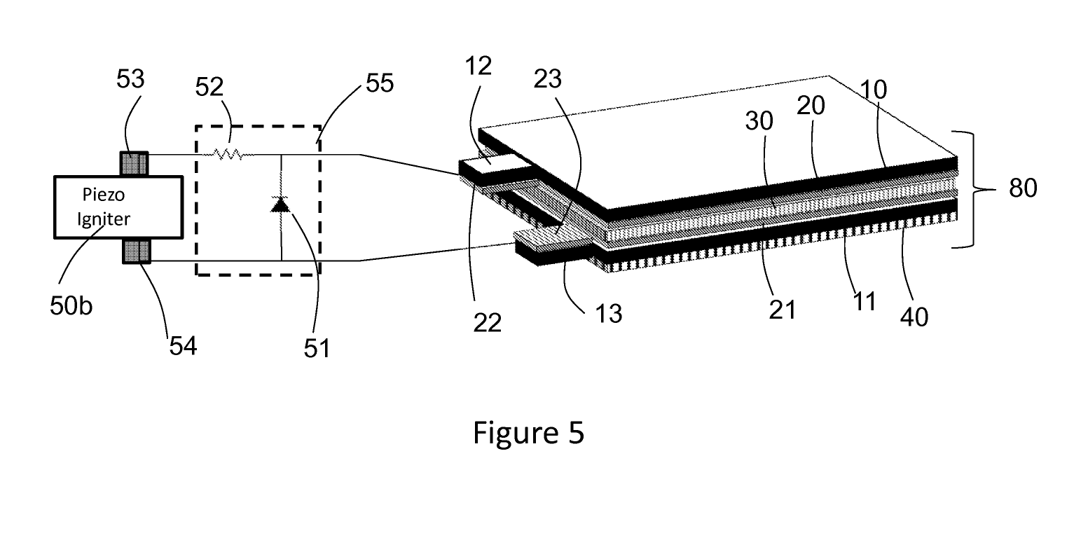

Example 2. A piezoelectric transducer from a commercial multipurpose piezoelectric flame igniter was used to erase a cholesteric liquid crystal display writing tablet. The writing tablet for this example was obtained from a commercial Boogie Board® product of Improv Electronics. The display from the Boogie Board® was cut with a pair of scissors to a size of 1 inch×3 inches while keeping the two electrode terminals as part of the display. The resulting display 80 is illustrated schematically in FIG. 5. The piezo igniter 50b was from a Click n Flame™ multipurpose lighter. The multipurpose lighter was disassembled and the piezo igniter including a “snap-action switch” as referred to in the Piezo Film Technical Manual of SI Images, Inc., publically accessible as least as early as Jun. 6, 2013, to provide a mechanical force (impulse) and electrical leads for extracting the resulting electrical signal were taken from the lighter for use as the transducer. As illustrated in FIG. 5, one of the electrical leads from the terminal 53 of transducer 50b is connected to a 100 kΩ resistor 52 in series with one of the writing tablet electrode terminals 22 of the writing tablet 80. The other lead from the transducer terminal 54 is connected directly to the remaining terminal 23 of the writing tablet. A diode 51 is connected in parallel with the terminals 22 and 23 of the writing tablet 80. The resulting circuit 55 served to shape the pulse so as to transfer charge from the transducer to the display. When the trigger on the “snap-action switch” device of the igniter transducer 50b was compressed, the piezo igniter produced a spiked electrical pulse with a maximum amplitude >200V decaying approximately exponentially to 0 V over a period of 2.5 ms as measured across the diode. An image was written on the display with the slight pressure of a pointed stylus (bright planar writing with surrounding areas in the focal conic texture appearing dark). The image was erased and the entire viewing area was placed in the focal conic state after compressing the piezo igniter four consecutive times.

Many modifications and variations of the disclosed embodiments will be apparent to those of ordinary skill in the art in light of the foregoing disclosure. Therefore, it is to be understood that, within the scope of the appended claims, the invention can be practiced otherwise than has been specifically shown and described.

What is claimed is:

1. A display device comprising a cholesteric liquid crystal writing tablet and a piezoelectric transducer, wherein said piezoelectric transducer is subjected to a mechanical force that generates a voltage that is applied to said writing tablet that erases writing on said writing tablet.

2. The display device of claim 1 wherein said erasing is carried out by said voltage placing said writing tablet in a focal conic texture.

3. The display device of claim 1 wherein said display device includes no batteries.

4. The display device of claim 1 wherein a piezoelectric material of said piezoelectric transducer is a piezoceramic crystal or piezoelectric polymer.

5. The display device of claim 4 wherein said piezoceramic crystal is barium titanate or lead zirconate titanate.

6. The display device of claim 4 wherein said piezoelectric polymer is polyvinylidene fluoride or a copolymer thereof

7. The display device of claim 4 comprising a snap-action switch that provides said mechanical force to said piezoelectric transducer that results in application of said voltage to said writing tablet.

8. The display device of claim 1 wherein a material of said piezoelectric transducer comprises a complex of piezoelectric powder or piezoelectric particles dispersed in polymeric binder.

9. The display device of claim 1 said piezoelectric transducer comprising two electrical electrodes electrically connected to leads of said writing tablet.

10. The display device of claim 1 wherein said voltage comprises voltage pulses.

11. The display device of claim 1 wherein said piezoelectric transducer comprises a stack of piezoelectric sheets comprising piezoelectric polymer, electrically connected in parallel.

12. The display device of claim 11 comprising a device that applies said mechanical force to said piezoelectric sheets that results in application of said voltage to said writing tablet.

13. The display device of claim 1 comprising a device that applies said mechanical force to said piezoelectric transducer that results in application of said voltage to said writing tablet.

14. A display device comprising a cholesteric liquid crystal display and a piezoelectric transducer, wherein said piezoelectric transducer is subjected to a mechanical force that generates a voltage that is applied to said display that places said display in at least one of a color reflective planar state, a substantially transparent focal conic state and a gray scale state.

15. The display device of claim 14 comprising a device that applies said mechanical force to said piezoelectric transducer that results in application of said voltage to said writing tablet.

16. A method of erasing a cholesteric liquid crystal writing tablet comprising:
providing a piezoelectric transducer and a cholesteric liquid crystal writing tablet, and applying a mechanical force that deforms said piezoelectric transducer so as to apply a voltage to said writing tablet that erases writing on said writing tablet or a portion thereof

17. The method of claim 16 wherein said erasing is carried out by said application of said voltage placing said writing tablet into a focal conic texture.

18. The method of claim 16 comprising applying no voltage from batteries to said writing tablet.

19. The method of claim 16 said piezoelectric transducer comprising two electrical electrodes electrically connected to leads of said writing tablet, and applying said voltage from said electrodes to said leads.

20. The method of claim 16 wherein said deformation of said piezoelectric transducer generates said voltage of an amplitude and duration.

21. The method of claim 20 wherein said voltage comprises voltage pulses.

22. The method of claim 16 wherein said piezoelectric transducer comprises a stack of piezoelectric sheets comprising piezoelectric polymer, electrically connected in parallel and providing a device that applies said mechanical force that bends said piezoelectric sheets so as to result in application of said voltage to said writing tablet.

23. The method of claim 16 comprising providing a device that applies said mechanical force to said piezoelectric transducer that results in application of said voltage to said writing tablet.

24. The method of claim 16 wherein said deforming occurs by applying said mechanical force that bends said piezoelectric transducer.
